(19) United States
(12) Patent Application Publication
(10) Pub. No.: US 2008/0052431 A1
(43) Pub. Date: Feb. 28, 2008

(54) Method and Apparatus for Enabling Virtual Channels Within A Peripheral Component Interconnect (PCI) Express Bus

(76) Inventors: Ronald E. Freking, Rochester, MN (US); Ryan S. Haraden, Rochester, MN (US); Adalberto G. Yanes, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/466,136

(22) Filed: Aug. 22, 2006

(51) Int. Cl. G06F 13/00

(52) U.S. Cl. 710/104

(57) ABSTRACT

A method for enabling virtual channels within a Peripheral Component Interconnect (PCI) Express chipset is disclosed. A first determination is made as to whether or not bifurcation is enabled on a PCI Express chipset. If bifurcation is enabled, a second determination is made as to whether or not all resources associated with the bifurcation are being utilized. If all resources associated with the bifurcation are not being utilized, the PCI Express configuration space is changed to provide support for virtual channels by mapping a set of virtual channels to available resources associated with the bifurcation.

### BACKGROUND OF THE INVENTION

1. Technical Field

The present invention relates to Peripheral Component Interconnect (PCI) Express buses in general, and in particular to a method and apparatus for managing resources within PCI Express buses. Still more particularly, the present invention relates to a method and apparatus for enabling virtual channels within a PCI Express chipset.

2. Description of Related Art

The Peripheral Component Interconnect (PCI) standard was first introduced in the early 1990s. By using a PCI bridge chip connected to a frontside bus and a processor, PCI provides direct access to a system memory within a computer system for any peripheral devices connected to a PCI bus. The PCI bridge chip regulates the speed of the PCI bus independent of the speed of the processor such that a high degree of reliability can be achieved.

The PCI Express standard is the successor to the PCI standard, the pertinent of which is incorporated herein by reference. Compared to PCI, PCI Express can achieve a higher transmission rate with less physical pins. PCI Express applies point-to-point transmissions. For each end point, each PCI Express bus has a signal transmission pair and a signal reception pair. PCI Express allows for interfaces with different widths, such as single lane, 4 lanes, 8 lanes, 16 lanes and 32 lanes, in order to meet the different bandwidth requirements of various peripheral devices. For example, a graphics card that requires a relatively large bandwidth may use a 32-lane interface, while a pointing device that requires a relatively low bandwidth may use a single lane interface.

In addition to physical lanes, PCI Express also allows for virtual channels. Basically, the bandwidth of one physical lane can be divided into several virtual channels. As a result, software can divide the bandwidth on one link among various peripheral devices. However, virtual channels are not widely used in PCI Express chipsets because, according to the PCI Express standard, each virtual channel is supposed to be totally independent from all other virtual channels associated with their respective physical lane. In other words, each virtual channel must have its own buffer and logic controls, and such requirement can significantly increase cell counts to the PCI Express chipsets.

Consequently, it would be desirable to provide an improved method and apparatus for enabling virtual channels within a PCI Express chipset.

### SUMMARY OF THE INVENTION

In accordance with a preferred embodiment of the present invention, a first determination is made as to whether or not bifurcation is enabled on a PCI Express chipset. If bifurcation is enabled, a second determination is made as to whether or not all resources associated with the bifurcation are being utilized. If all resources associated with the bifurcation are not being utilized, the PCI Express configuration space is changed to provide support for virtual channels by mapping a set of virtual channels to available resources associated with the bifurcation.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of a Peripheral Component Interconnect (PCI) Express bus topology in which a preferred embodiment of the present invention is incorporated; and

FIG. 2 is a high-level logic flow diagram of a method for enabling virtual channels within a PCI Express chipset, in accordance with a preferred embodiment of the present invention.

### DETAILED DESCRIPTION OF A PREFERRED EMBODIMENT

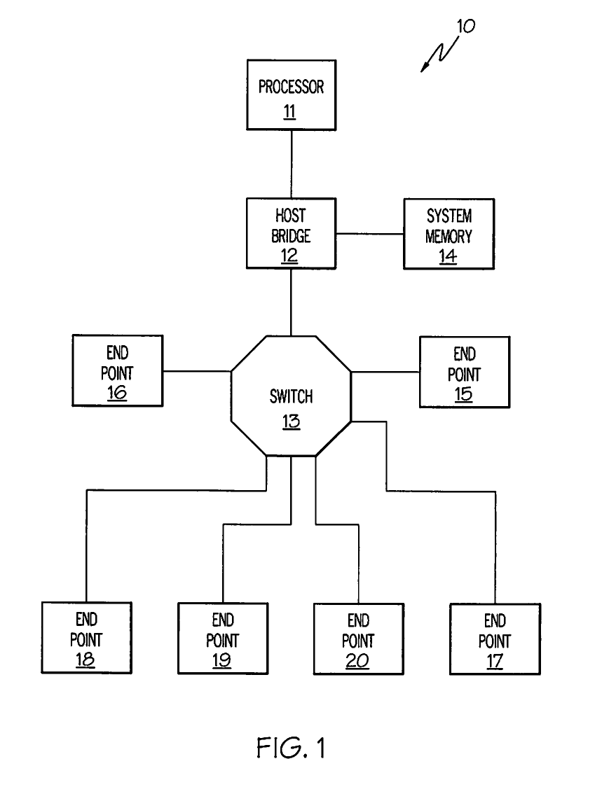

Referring now to the drawings and in particular to FIG. 1, there is depicted a block diagram of a Peripheral Component Interconnect (PCI) Express bus topology in which a preferred embodiment of the present invention is incorporated. As shown, a PCI Express topology 10 includes a host bridge 12 and endpoints 15-20 to which PCI Express compliant peripheral devices can be connected. Host bridge 12 is connected to a processor 11 and a system memory 14. Multiple point-to-point connections are accomplished by a switch 13.

Switch 13, which replaces the multi-drop bus used by PCI, provides fan-out for input/output buses. In addition, switch 13 also facilitates peer-to-peer communications among endpoints 15-20.

PCI Express provides multiple physical lanes, such as single lane, 4 lanes, 8 lanes, 16 lanes and 32 lanes, in order to accommodate the different bandwidth requirements of PCI Express compliant peripheral devices. A link is a dual-simplex communications path between two components. Logically, a port is an interface between a component and a PCI Express link. Physically, a port is a group of transmitters and receivers located on a same chip that define a link. A link must support at least one lane—each lane represents a set of differential signal pairs (one transmission pair and one reception pair). In order to scale bandwidth, a link may aggregate multiple lanes denoted by xN, where N is one of the supported link widths. For example, x1 denotes a link having one physical lane, and x8 denotes a link having eight physical lanes.

PCI Express also allows for virtual channels to maximize bandwidth distributions. With virtual channels, software can divide the bandwidth on one link among various peripheral devices. However, according to the PCI Express specification, each virtual channel has to be totally independent from all other virtual channels associated with their respective physical lane. Thus, each virtual channel must have its own buffer and logic controls, and software cannot create new virtual channels because they are functions of hardware buffering.

Bifurcation is a physical division of a link into multiple lanes, such as dividing one 16× link into two 8× links, without changing any hardware. Bifurcation is not subject to software control, and the division is permanent based on the hardware design.

While virtual channels have not been widely supported in PCI Express chipsets because of the additional buffering overhead, bifurcations can be found in many PCI Express chipsets.

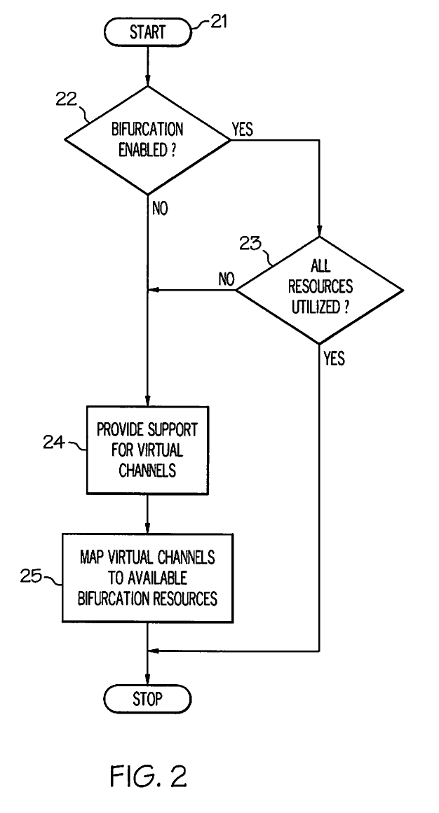

Since bifurcation is a fixed mapping of resources, the associated buffers and control structure are not utilized when bifurcation is not enabled. Thus, the associated buffers and control structure can be conveniently diverted to handle virtual channels when bifurcation is not enabled. With reference now to FIG. 2, there is depicted a high-level logic flow diagram of a method for enabling virtual channels within a PCI Express chipset, in accordance with a preferred embodiment of the present invention. Starting at block 21, a determination is made as to whether or not bifurcation is enabled, as shown in block 22. If bifurcation is not enabled, the process proceeds to block 24. If bifurcation is enabled, another determination is made as to whether or not all the resources, such as buffers, associated with the bifurcation are being utilized, as depicted in block 23.

If all the resources associated with the bifurcation are being used, the process proceeds to end. However, if all the resources associated with the bifurcation are not being used, the PCI Express configuration space is changed to provide support for virtual channels, and the virtual channels are matched up with the available bifurcation resources, as shown in block 24. The virtual channels are then mapped to the available bifurcation resources (which should already have full buffering and control logic available to them), as depicted in block 25.

Each link effectively needs one virtual channel, and when there is only one virtual channel, the channel is no longer “virtual” as the channel has a one-to-one correspondence with the link. Thus, the number of additional virtual channels a chipset can support depends on the amount of bifurcation resources that are not being utilized. As an example, a chip is designed to support a 16× lanes bifurcated to two 8× lanes. Assuming one of the two 8× lanes is called link A and the other 8× lane link B. When the bifurcation is enabled, link A uses the first 8 lanes, and link B uses the second 8 lanes. When the bifurcation is not enabled, only one physical port exists at the 16× lanes, which is then connected as link A. Thus, a second virtual channel can be turned on for the 16× lanes. All traffics destined for the first virtual channel will be handled by link A, as before, and all traffics destined for the second virtual channel will now be handled by link B. An arbitration logic can be utilized to fairly arbitrate the traffics between the first and second virtual channels to and from the physical port.

As has been described, the present invention provides an improved method and apparatus for enabling virtual channels within a PCI Express chipset. The present invention bridges the gap between virtual channels and bifurcation by sharing the buffer requirements between virtual channels and bifurcation. Conventionally, the buffering requirements of a chip is

total buffer per port=virtual channels supported×bifurcation allowed×buffer required per virtual channel

The buffer required per virtual channel is typically a constant, and the virtual channels supported by software is also a constant. However, with the present invention, the virtual channels supported by software is no longer a constant. Thus,

virtual channels supported=total buffer per port/(bifurcation allowed×buffer required per virtual channel)

For example, on a chip designed for 16 k of PCI Express buffering, each lane requires 4 k of fixed buffering, and if the chip needs to support bifurcation from one 16× lane to two 8× lanes. With the prior art, the buffer size for supporting two virtual channels is

16 k=two virtual channels×two bifurcations×4 k

With the present invention, if a chip is configured as a 16× lane, the chip can support 4 virtual channels, or if a chip is configured as two 8× lanes, the chip can support 4 virtual channels but one of the four virtual channels can be assigned to one of the ports, and the remaining three virtual channels can be assigned to the other ports.

It is also important to note that although the present invention has been described in the context of a fully functional computer system, those skilled in the art will appreciate that the mechanisms of the present invention are capable of being distributed as a program product in a variety of forms, and that the present invention applies equally regardless of the particular type of signal bearing media utilized to actually carry out the distribution. Examples of signal bearing media include, without limitation, recordable type media such as floppy disks or compact discs and transmission type media such as analog or digital communications links.

While the invention has been particularly shown and described with reference to a preferred embodiment, it will be understood by those skilled in the art that various changes in form and detail may be made therein without departing from the spirit and scope of the invention.

What is claimed is:

1. A method for enabling virtual channels within a peripheral bus chipset, said method comprising:
determining whether or not bifurcation is enabled;
in a determination that said bifurcation is enabled, determining whether or not all resources associated with said bifurcation are being utilized; and
in a determination that not all resources associated with said bifurcation are being utilized, changing a configuration space to provide support for virtual channels by mapping virtual channels to available resources associated with said bifurcation.

2. The method of claim 1, wherein said method further includes in a determination that said bifurcation is not enabled, changing a configuration space to provide support for virtual channels by mapping virtual channels to all resources associated with said bifurcation.

3. The method of claim 1, wherein said method further includes in a determination that all resources associated with said bifurcation are being utilized, exiting said process.

4. The method of claim 1, wherein said resources associated with said bifurcation include buffers and related logic controls.

5. The method of claim 1, wherein said peripheral bus chipset is a Peripheral Component Interconnect (PCI) Express chipset.

6. A computer usable medium having a computer program product for enabling virtual channels within a peripheral bus chipset, said computer usable medium comprising:
program code means for determining whether or not bifurcation is enabled;
program code means for, in a determination that said bifurcation is enabled, determining whether or not all resources associated with said bifurcation are being utilized; and
program code means for, in a determination that not all resources associated with said bifurcation are being utilized, changing a configuration space to provide support for virtual channels by mapping virtual channels to available resources associated with said bifurcation.

7. The computer usable medium of claim 6, wherein said computer usable medium further includes program code means for, in a determination that said bifurcation is not enabled, changing a configuration space to provide support for virtual channels by mapping virtual channels to all resources associated with said bifurcation.

8. The computer usable medium of claim 6, wherein said computer usable medium further includes program code means for, in a determination that all resources associated with said bifurcation are being utilized, exiting said process.

9. The computer usable medium of claim 6, wherein said resources associated with said bifurcation include buffers and related logic controls.

10. The computer usable medium of claim 6, wherein said peripheral bus chipset is a Peripheral Component Interconnect (PCI) Express chipset.

11. A computer system capable of enabling virtual channels within a peripheral bus chipset, said computer system comprising:
means for determining whether or not bifurcation is enabled;
means for, in a determination that said bifurcation is enabled, determining whether or not all resources associated with said bifurcation are being utilized; and
means for, in a determination that not all resources associated with said bifurcation are being utilized, changing a configuration space to provide support for virtual channels by mapping virtual channels to available resources associated with said bifurcation.

12. The computer system of claim 11, wherein said computer system further includes program code means for, in a determination that said bifurcation is not enabled, changing a configuration space to provide support for virtual channels by mapping virtual channels to all resources associated with said bifurcation.

13. The computer system of claim 11, wherein said computer system further includes program code means for, in a determination that all resources associated with said bifurcation are being utilized, exiting said process.

14. The computer system of claim 11, wherein said resources associated with said bifurcation include buffers and related logic controls.

15. The computer system of claim 11, wherein said peripheral bus chipset is a Peripheral Component Interconnect (PCI) Express chipset.
